(19) United States
(12) Patent Application Publication
(10) Pub. No.: US 2014/0279656 A1
(43) Pub. Date: Sep. 18, 2014

(54) MULTI-CARRIER TRACKING SYSTEMS AND RELATED METHODS

(71) Applicant: United Parcel Service of America, Inc., Atlanta, GA (US)

(72) Inventors: Bala Ganesh, Alpharetta, GA (US); Scott Castaldo, Woodstock, GA (US); Amber Reed, Atlanta, GA (US)

(21) Appl. No.: 14/215,457

(22) Filed: Mar. 17, 2014

Related U.S. Application Data
(60) Provisional application No. 61/786,387, filed on Mar. 15, 2013.

(51) Int. Cl. G06Q 10/08

(52) U.S. Cl. CPC G06Q 10/0833
USPC 705/333

(57) ABSTRACT

A system for providing individuals with comprehensive shipping and online purchasing information is disclosed. The system receives online purchasing and shipping information associated with purchases, regardless of where an individual made the purchase (e.g., from any website), what items were purchased, and what carrier shipped the purchased items. The purchasing and shipping information is made available to the individual through an account and associated login. This allows individuals to conveniently view all shipping information and a detailed record of all online purchases in one location.

### CLAIM OF PRIORITY

This application claims the benefit of priority under 35 U.S.C. §119(e) to the filing date of U.S. Provisional Patent Application No. 61/786,387, filed Mar. 15, 2013, entitled, “Multi-Carrier Tracking Systems and Related Methods,” which is incorporated herein by reference in its entirety.

### BACKGROUND

When an individual orders a package from an online retailer, the online retailer (opposed to the individual) often selects a logistics company to deliver the package, or the individual may be given the option to choose a logistics company from a list that does not include their preferred logistics provider (e.g., UPS®). As a result, individuals who order items from many different retailers may receive items from a variety of different logistics companies. This may make it difficult for individuals to track the status of their inbound deliveries, since each logistics company is likely to have their own system for allowing consumers to track packages.

Various embodiments of the present systems and methods recognize and address the foregoing considerations, and others.

### SUMMARY

Generally, in various embodiments, a computer system includes at least one processor and is configured for: 1) receiving first purchasing data collected from a website associated with a first online retailer, the first purchasing data associated with a first purchase made by a user from the first online retailer; 2) receiving first shipping data collected from an email account associated with the user, the first shipping data associated with the first purchase and wherein the first shipping data includes a first tracking number associated with a first common carrier; 3) receiving second purchasing data collected from a second retailer website and associated with a second purchase made by the user from the second online retailer; 4) receiving second shipping data collected from the email account associated with the user, the second shipping data associated with the second purchase and wherein the second shipping data includes a second tracking number associated with a second common carrier; 5) receiving first tracking information associated with the first tracking number; 6) receiving second tracking information associated with the second tracking number; 7) associating the first tracking information and the first shipping data with the first purchasing data; 8) associating the second tracking information and the second shipping data with the second purchasing data; and 9) saving to memory: i) the associated first purchasing data, first tracking information, and first shipping data; and ii) the associated second purchasing data, second tracking information, and second shipping data.

According to a particular embodiment, a non-transitory computer-readable medium stores computer executable instructions for: 1) detecting a first purchase from a first online retailer by a first user; 2) collecting, from a website of the first online retailer, first purchasing data associated with the first purchase; 3) collecting, from an email account associated with the first user, first shipping data associated with the first purchase, wherein the first shipping data includes a first tracking number associated with one or more parcels associated with a first common carrier; 4) detecting a second purchase from a second online retailer by the first user; 5) collecting, from a website of the second online retailer, second purchasing data associated with the second purchase; 6) collecting, from the email account associated with the first user, second shipping data associated with the second purchase, wherein the second shipping data includes a second tracking number associated with one or more parcels associated with a second common carrier; and 7) sending, to a computer system, the first purchasing data, the first shipping data, the second purchasing data, and the second shipping data, wherein the computer system is configured to receive the first tracking number and, at least partially based on receiving the first tracking number, request, from the first common carrier, tracking information associated with the first tracking number.

### BRIEF DESCRIPTION OF THE DRAWINGS

Reference will now be made to the accompanying drawings, which are not necessarily drawn to scale, and wherein:

FIG. 1 is a block diagram of a Multi-Carrier Tracking System according to one embodiment;

FIG. 2 is a block diagram of an exemplary Logistics Server of FIG. 1;

FIGS. 3A and 3B shows a flow diagram that generally illustrates various steps executed by the exemplary Multi-Carrier Tracking Module in FIG. 2 in accordance with various embodiments of the system of FIG. 1; and

FIGS. 4A and 4B depict screenshots and descriptions of various aspects and embodiments of the exemplary Multi-Carrier Tracking Module of FIG. 2.

### DETAILED DESCRIPTION OF VARIOUS EMBODIMENTS

Various embodiments will be described more fully hereinafter with reference to the accompanying drawings. It should be understood that the invention may be embodied in many different forms and should not be construed as limited to the embodiments set forth herein. Like numbers refer to like elements throughout.

### System Overview

A computer system, according to various embodiments, provides an interface where a user of the computer system can track any items purchased online, regardless of: 1) where the user makes a purchase (e.g., from which online retailer); and 2) which common carrier ships the parcels containing the purchased items of the online purchase. In various embodiments, the computer system is configured to: 1) receive purchase data associated with a purchase made by the user (e.g., the one or more items purchased, the purchase order number, the price paid for each of the one or more items, etc.); 2) receive shipping data associated with the purchase from an email account associated with the user (e.g., the tracking number associated with the one or more parcels used by a common carrier to ship the one or more purchased items); 3) receive tracking information associated with the tracking number (e.g., so the user can track the one or more parcels); 4) associate the purchasing data, the shipping data, and the tracking information in memory; and 5) enable the user to access the associated data (e.g., so the user can see the purchase data, the shipping data, and the tracking information in a single location for the one or more parcels).

The system may be configured to collect purchase data in any suitable way. In some embodiments, the system collects purchase data from the online retailer website by identifying and collecting the purchase data when the user views a receipt or online purchase confirmation (e.g., the system examines the data of an online retailer website as the user is making a purchase and collects the data). In other embodiments, the system receives the purchase data directly from an online retailer's servers (e.g., the one or more Third Party Servers 35).

In various embodiments, the system collects the shipping data via a user's email (e.g., a confirmation e-mail for a purchase made by the user)—by either scraping the email (e.g., searching for data in the background of an email) or by using a browser plug-in to collect the shipping data with the user opens and email (e.g., the browser plug-in “sees” the information that is on a user's screen and collects shipping information). The shipping data, in various embodiments, includes a tracking number associated with one or more parcels containing items of the online purchase made the user.

According to a particular embodiment, the system is configured to submit the tracking number to the appropriate common carrier to obtain the tracking information associated with the one or more parcels (e.g., estimated delivery date, tracking details such as where the one or more parcels was last scanned). For example, in one embodiment, the system may use an appropriate API to access the information from an appropriate computer system associated with the common carrier. After obtaining the tracking information, the system, in various embodiments, may save and display the purchase data, the shipping data, and the tracking information to the user (e.g., if the user submits the tracking number to the system, the system may display the related purchase, shipping, and tracking data/information).

According to particular embodiments, the system also enables the user to request changes to one or more certain details shown in the tracking information. In a particular example, the system enables the user to change the expected delivery date (e.g., the date the parcel is scheduled to arrive at the ship-to address). In various embodiments, the system is configured to enable the user to select a user-selectable indicium in order to access features and options (such as a separate webpage to request changes through email, or to manually input the changes and submit them) to request changes to the one or more details of the tracking information.

In various embodiments, the computer system is provided by a logistics company or any other suitable company that can access consumer data. Additionally, the system may be rendered on a user's computing device (e.g., desktop computer, mobile computing device, etc.), on a company's servers, a social network server, a third party server (e.g., a retailer's server), or any combination of user's devices and servers.

### Exemplary Technical Platforms

As will be appreciated by one skilled in the relevant field, the present invention may be, for example, embodied as a computer system, a method, or a computer program product. Accordingly, various embodiments may be entirely hardware, entirely software, or a combination of hardware and software. Furthermore, particular embodiments may take the form of a computer program product stored on a computer-readable storage medium having computer-readable instructions (e.g., software) embodied in the storage medium. Various embodiments may also take the form of web-implemented computer software. Any suitable computer-readable storage medium may be utilized, including, for example, hard disks, compact disks, DVDs, optical storage devices, and/or magnetic storage devices.

Various embodiments are described below with reference to block diagrams and flowchart illustrations of methods, apparatus (e.g., systems), and computer program products. It should be understood that each element of the block diagrams and flowchart illustrations, and combinations of elements in the block diagrams and flowchart illustrations, respectively, can be implemented by a computer executing computer program instructions. These computer program instructions may be loaded onto a general purpose computer, a special purpose computer, smart mobile device, or other programmable data processing apparatus to produce a machine. As such, the instructions which execute on the general purpose computer, special purpose computer, smart mobile device, or other programmable data processing apparatus create means for implementing the functions specified in the flowchart block or blocks. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

These computer program instructions may also be stored in a computer-readable memory that can direct a computer or other programmable data processing apparatus to function in a particular manner such that the instructions stored in the computer-readable memory produce an article of manufacture that is configured for implementing the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Accordingly, block diagram elements and flowchart illustrations support combinations of mechanisms for performing the specified functions, combinations of steps for performing the specified functions, and program instructions for performing the specified functions. It should also be understood that each block diagram element and flowchart illustration, and combinations of block diagram elements and flowchart illustrations, can be implemented by special purpose hardware-based computer systems that perform the specified functions or steps, or combinations of special purpose hardware and other hardware executing appropriate computer instructions.

### Exemplary System Architecture

FIG. 1 shows a block diagram of a Multi-Carrier Tracking System 10 according to a particular embodiment. As may be understood from this figure, the Multi-Carrier Tracking System 10 may include one or more Computer Networks 15, a Logistics Server 25, one or more Third Party Servers 35 (e.g., a web hosting server, retailer's server, any other server that hosts websites), a Social Network Server 45 (e.g., a server associated with a social network), and one or more of the following: (1) a Mobile Computing Device 12 (e.g., a handheld computing device, a laptop computer, a tablet computer, or any other mobile computing device); and (2) a Desktop Computer 14.

The one or more Networks 15 facilitate communication between the Mobile Computing Device 12, Desktop Computer 14, Logistics Server 25, Third Party Servers 35, and Social Network Server 45. These one or more Networks 15 may include any of a variety of types of computer networks such as the Internet, a private intranet, a public switch telephone network (PSTN), WAN, LAN, or any other type of suitable network. In certain variations of the embodiment shown in FIG. 1, the communication link between the Mobile Computing Device 12, the Desktop Computer 14, the Logistics Server 25, the one or more Third Party Servers 35, and the Social Network Server 45 may be implemented via the Internet using Internet Protocol (IP).

It should be understood that the Servers 25, 35, and 45 do not necessarily need to be deployed over the network. For example, in various embodiments, any or all of Servers 25, 35, and 45 may be deployed locally on the user's computer, tablet, and/or mobile device.

FIG. 2 shows a block diagram of an exemplary embodiment of an exemplary Logistics Server 25 that is configured for executing a Multi-Carrier Tracking Module 300. It should be understood based on this disclosure that any suitable computers (e.g., any of the computing devices shown in FIG. 1) may be used to execute this module and that various steps executed by the module may be executed on different computers.

The Logistics Server 25 may include several basic computer hardware components. As may be understood from FIG. 2, in this embodiment, the Logistics Server 25 includes a Processor 60 that communicates with other elements within the Logistics Server 25 via a System Interface or Bus 61. The Logistics Server 25 also includes a Display Device/Input Device 64 for receiving and displaying data. This Display Device/Input Device 64 may be, for example, a keyboard, voice recognition, or pointing device that is used in combination with a monitor. The Logistics Server 25 further includes a Memory 66, which preferably includes both a Read Only Memory (ROM) 65 and a Random Access Memory (RAM) 67. The server's ROM 65 may be used to store a Basic Input/Output System (BIOS) 26 that contains the basic routines that help to transfer information between elements within the Logistics Server 25.

Also located within the Logistics Server 25 is a Network Interface 74 for interfacing and communicating with other elements of a computer network. It will be appreciated by one of ordinary skill in the art that one or more components of the Logistics Server 25 may be located geographically remote from other components of the Logistics Server 25 and/or that certain components may be omitted from particular embodiments. Furthermore, one or more of the components may be combined, and additional components performing functions described herein may be included in the Logistics Server 25.

The Logistics Server 25 may also include at least one Storage Device 63, such as a hard disk drive, a floppy disk drive, a CD Rom drive, or an optical disk drive, for storing information on various computer-readable media, such as a hard disk, a removable magnetic disk, or a CD-ROM disk. As will be appreciated by one of ordinary skill in the art, each of these Storage Devices 63 may be connected to the Bus 61 by an appropriate interface. The Storage Devices 63 and their associated computer-readable media may provide nonvolatile storage for the Logistics Server 25. It should be noted that the computer-readable media described above could be replaced by any other type of computer-readable media known in the art. Such media includes, for example, magnetic cassettes, flash memory cards, and digital video disks.

A number of program modules may be stored by the various storage devices and/or within the RAM 67. Such program modules include an Operating System 80 and the Multi-Carrier Tracking Module 300. For simplicity and brevity, these modules are merely exemplary and may represent a number of program modules which control certain aspects of the operation of the Logistics Server 25 with the assistance of the Processor 60 and the Operating System 80. The Multi-Carrier Tracking Module 300 is described in more detail below.

### Exemplary Multi-Carrier Tracking Module

As shown in FIGS. 3A and 3B, certain embodiments of the Multi-Carrier Tracking Module 300 are configured to collect purchasing and shipping data and to enable a user to view and, in various embodiments, modify shipping details in response to receiving a tracking number. The Multi-Carrier Tracking Module 300 may operate alone or in combination with the Operating System 80 to perform the functions shown in FIGS. 3A and 3B. It should be understood by one skilled in the art that certain embodiments of the Multi-Carrier Tracking Module 300 may perform the functions shown in FIGS. 3A and 3B in an order other than the order shown in FIGS. 3A and 3B. It should also be understood that various systems, when executing the Multi-Carrier Tracking Module 300, may omit particular functions or executing additional functions in performing the functions of the Multi-Carrier Tracking Module 300.

### Exemplary Embodiment of the Multi-Carrier Tracking Module Shown in FIG. 3

### The System Receives Data and Information

Beginning at Step 302, the Multi-Carrier Tracking Module 300 receives first purchasing data collected from a website associated with a first online retailer, the first purchasing data associated with a first purchase made by a user from the first online retailer. The system may be configured to receive the first purchasing data from any suitable mechanism that is capable of collecting data from a website associated with a retailer. In various embodiments, the system is configured to receive the first purchasing data from one or more third party servers (e.g., the one or more Third Party Servers 35) that collects purchasing data associated with the user (e.g., the first online retailer's server or servers).

According to particular embodiments, the system is configured to receive the first purchasing data from a web-browser plug-in that has been downloaded onto a client device associated with the user. In various embodiments, the first purchasing data is collected by scraping an email account associated with the user (e.g., searching for data in the background of an email). In various embodiments, the web-browser plug-in may be configured to detect when the user makes an online purchase and to collect purchasing data when the first online retailer displays one or more purchase order numbers to the user on a webpage (e.g., the web browsers “sees” the webpages accessed by the user and collects the one or more purchase order numbers from a webpage associated with the first online retailer). In further embodiments, the first purchasing data is collected when the user sends a confirmation email for a purchase to the system or to an email account that the system is configured to access. In still further embodiments, the first purchasing data is collected through an add-on which has been installed on an email client (e.g., Outlook®) associated with an account of the user.

The website (from which purchasing data, in various embodiments, is collected) may be associated with the first online retailer in one or more suitable ways. In various embodiments, the website is associated with the first online retailer by the first online retailer owning the website or the content of the website. In other embodiments, the website is owned by a third-party, but is associated with the first online retailer by the third-party website conducting sales associated with the first online retailer (e.g., a third-party website that conducts the sales for the first online retailer, such as eBay® or Amazon®).

The first online retailer may be any online retailer. In various embodiments, the first online retailer is a retailer that sells one or more various brands, but specializes in a specific type of merchandise (e.g., an online shoe retailer). In other embodiments, the first online retailer specializes in one specific brand (e.g., Calvin Klein®). In still other embodiments, the first online retailer is a general online retailer (e.g., Amazon®).

The first purchasing data may include any suitable purchasing data such as, for example: 1) a first purchase order number associated with a first purchase made by the user; 2) a description of one or more items of the first purchase by the user; 3) the one or more prices paid by the user for one or more items purchased in the first purchase; 4) a date the user made the first purchase; and/or 5) data associated with the user making the first purchase (e.g., an account number associated with the first user, billing address of the user, shipping address of the user, etc.).

Continuing with Step 304, the system receives first shipping data collected from an email account associated with the user, the first shipping data associated with the first purchase and wherein the first shipping data includes a first tracking number associated with a first common carrier. The system may be configured to receive the first shipping data in any suitable way, including any of the ways (or other ways) as the system may be configured to receive the first purchasing data in Step 302.

The first shipping data may be collected from an email account in one or more suitable ways. In various embodiments, the first shipping data is collected by scraping the email account associated with the user (e.g., searching for the first shipping data in the background an email account associated with the user). In other embodiments, the first shipping data is collected by a browser plug-in installed on a client device of the user, which collects the first shipping data when the user opens an email (e.g., the browser plug-in “sees” the information that is on a user's screen and collects shipping information from an email account or webpage when the email or webpage is accessed by the user). In further embodiments, the first shipping data is collected when the user sends a confirmation email, sent from the first online retailer to the user regarding the first purchase, to the system or to an email account that the system is configured to access. In still further embodiments, the first shipping data is collected through an add-on which has been installed on an email client (e.g., Outlook®) associated with an account of the user on a client device.

The first shipping data may include any suitable shipping data from any common carrier. In various embodiments, the first shipping data includes the first tracking number associated with one or more parcels used by the first common carrier to ship the items of the first purchase. The tracking number may, for example, take the form of any alphanumeric strings and/or symbols that correspond to the standard format of a particular tracking number associated with the first common carrier (for example, UPS' tracking numbers typically begin with the characters “1Z”).

In a particular embodiment, the first shipping data includes, for example: 1) the first purchase order number associated with the first purchase; 2) the name of the first common carrier used to ship the one or more parcels associated with the first purchase; 3) one or more details about the first common carrier (e.g., how to contact the first common carrier, where the first common carrier is located, etc.); and/or 4) data associated with the user making the first purchase (e.g., an account associated with the user). The first shipping data may, in various embodiments, include data that is similar or identical to data included in the first purchasing data. In a particular example, the first shipping data and the first purchasing data may include the first purchase order number associated with the first purchase by the user.

Returning to Step 306, the System 10 receives second purchasing data collected from a second retailer website and associated with a second purchase made by the user from the second online retailer. The system may be configured to receive the second purchasing data in any of the ways (or other ways) as described in Step 302. The website may be associated with the second online retailer in one or more suitable ways, including those ways described in Step 302.

The second purchasing data may include any suitable purchasing data such as, for example: 1) a second purchase order number associated with a second purchase made by the user; 2) a description of one or more items of the second purchase by the user; 3) the one or more prices paid by the user for one or more items purchased; 4) a date the user made the second purchase; and/or 5) data associated with the user making the second purchase (e.g., an account number associated with the first user, billing address of the user, shipping address of the user, etc.).

The second retailer may be any suitable online retailer. According to a particular embodiment, the second online retailer is the same retailer as the first online retailer. In various embodiments, the second online retailer may be, for example, any type of online retailer (or other type of online retailer) as the various online retailers discussed in Step 302.

According to a particular embodiment, the second purchase may be for the same one or more items as in the first purchase by the user. In other embodiments, the second purchase is for different items as the items in the first purchase by the user. In various embodiments, the second purchase is for one or more items related to the items in the first purchase by the user. In a particular example, the second purchase is for items that are accessories to the items in the first purchase by the user (e.g., the items in the first purchase are for a children's toy that takes “AA” size batteries and the items in the second purchase are “AA” size batteries).

At Step 308, the system receives second shipping data collected from the email account associated with the user, the second shipping data associated with the second purchase and wherein the second shipping data includes a second tracking number associated with a second common carrier. In various embodiments, the system is configured to receive the second shipping data in any suitable way, including the ways described in Step 304. According to a particular embodiment, the second shipping data is collected in any suitable way, including, but not limited to, the ways the first shipping data is collected in Step 304.

The second shipping data may include any suitable shipping data such as, for example: 1) the second purchase order number associated with the second purchase; 2) the second tracking number (which may be, for example, any string of alphanumeric characters or symbols associated with one or more parcels used to ship the one or more items associated with the second purchase); 3) the name of the second common carrier used to ship the one or more parcels associated with the second purchase; 4) one or more details about the second common carrier (e.g., how to contact the second common carrier, where the second common carrier is located, etc.); and/or 5) data associated with the user making the second purchase. The second shipping data may, in various embodiments, include data that is similar or identical to data included in the second purchasing data. In a particular example, the second shipping data and the second purchasing data may both include the second purchase order number associated with one or more second purchases made by the user.

The second shipping data, in various embodiments, contains similar or the same data as the first shipping data. In a particular embodiment, the first shipping data and the second shipping data are associated with the same common carrier (e.g., the first common carrier and the second common carrier are the same common carrier). In other embodiments, the first shipping data and the second shipping data include the same tracking number (e.g., the first and second shipping data are associated with the same shipment). In further embodiments, the first shipping data and the second shipping data are associated with different common carriers.

Returning to Step 310, the system receives first tracking information associated with the first tracking number. The system may be configured to receive the first tracking information from any suitable source. In various embodiments, the system is configured to retrieve the first tracking information from a database which stores tracking information for particular users which is accessed by an account associated with the user. For example, the system may be configured to enable the user to login to an account through a website, receive the first tracking number from the user, and then, based on the account and tracking number, receive the first tracking information.

In still other embodiments, the system is configured to receive the first tracking information from a browser add-on installed on a client device associated with the user. According to a particular embodiment, the system is configured to receive the first tracking number through an API associated with one or more servers associated with the first carrier.

In various embodiments, the system is configured to receive the first tracking information by requesting the first tracking information from the first common carrier. The system may be configured to request the first tracking information in one or more suitable ways. In various embodiments, the system is configured to request the first tracking information from the first common carrier by submitting data (or a combination of data) associated with the first purchase, such as: 1) the first purchase order number; and/or 2) the data associated with the user making the first purchase (e.g., account information associated with the user). According to a particular embodiment, the system is configured to receive the first tracking information by requesting the first tracking information from the first common carrier and by transmitting the first tracking number to the first common carrier. In a particular example, the system submits the first tracking number to one or more servers (e.g., the one or more Third Party Servers 35) associated with the first common carrier and, at least partially in response to receiving the first tracking number, the first common carrier transmits the first tracking information to the system.

According to various embodiments, the first tracking information includes: 1) an expected delivery date for the one or more parcels associated with the first purchase; and 2) a delivery status for the one or more parcels associated with the first purchase. The expected delivery date, in various embodiments, is the future date the one or more parcels are scheduled to arrive at the user's shipping address. In other embodiments, the expected delivery date is the prior date the one or more parcels was scheduled to arrive at the user's shipping address (e.g., if the user is looking up a shipment that was scheduled to arrive in the past). In further embodiments, the expected delivery date is the date the one or more parcels are scheduled to arrive at a place other than the user's shipping address (e.g., if the user is tracking a parcel the user has shipped to someone else).

The delivery status is, in various embodiments, the current delivery status of the one or more parcels associated with the first purchase. For example, the delivery status may be “Delivered,” “In Transit,” or “Out For Delivery.” Additionally, the delivery status may provide further information. For example, in addition to “In Transit,” the delivery status may include further information pertaining to where the one or more parcels are currently located or the last check-point where the one or more parcels were scanned. In this example, in addition to “In Transit” the delivery status may also include information such as “Shipment received by carrier.”

It should be understood that, in various embodiments, the first tracking information is not limited to the expected delivery date and the delivery status of the one or more parcels associated with the first purchase. The tracking information may also include, but is not limited to: the first tracking number; information regarding the first common carrier transporting the one or more parcels associated with the first purchase; the shipping service (e.g. “UPS® Ground”) used to deliver the one or more parcels associated the first purchase; the first purchase order number; the shipping date of the one or more parcels associated with the first purchase (e.g., the date the one or more parcels left the first online retailer); the scheduled destination of the one or more parcels associated with the first purchase (e.g., Atlanta, Ga., U.S.A.); and the dates and times of events associated with the transportation of the one or more parcels associated with the first purchase (e.g., the details of the delivery status, such as “Feb. 21, 2013, 7:46:00 AM, Knoxville Tenn. U.S., Departure Scan”).

At Step 312, the system receives second tracking information associated with the second tracking number. The system may be configured to receive the second tracking information in any of the ways (or other ways) as the system receives the first tracking information in Step 310. The system may receive the second tracking information from any suitable source associated with the second carrier, including (but not limited to), the examples in Step 310. In further embodiments, the second tracking information includes any suitable tracking information, including, for example, the types of tracking information disclosed in Step 310.

### The System Associates the Received Data

Continuing to Step 314, the system associates the first tracking information, the first shipping data, and the first purchasing data. The system may associate the first tracking information, the first shipping data, and the first purchasing data in any suitable way. In various embodiments, the system is configured to associate the first tracking information, the first shipping data, and the first purchasing data by an account number associated with the user. In other embodiments, the system is configured to use any common data of the first tracking information, the first shipping data, and the first purchasing data to associate the first tracking information, the first shipping data, and the first purchasing data. In a particular example, the first tracking information, the first shipping data, and the first purchasing data all include the first purchase order number and the system matches and associates the three different types of information by the first purchase order number. In other embodiments, the system is configured to associate the first tracking information, the first shipping data, and the first purchasing data by the first tracking number (e.g., the first tracking information, the first shipping data, and the first purchasing data all include the first tracking number).

At Step 316, the system is configured to associate the second tracking information, the second shipping data, and the second purchasing data. The system, in various embodiments, is configured to associate the second tracking information and the second shipping data with the second purchasing data in any of the ways (or other ways) the system is configured to associate the first tracking information, the first shipping data, and the first purchasing data in Step 314.

The system then, at Step 318, is configured to save to memory: 1) the associated first purchasing data, first tracking information, and first shipping data; and 2) the associated second purchasing data, second tracking information, and the second shipping data. According to a particular embodiment, the system is configured to associate the associated first purchasing data, first tracking information, and first shipping data; and the associated second purchasing data, second tracking information, and second shipping data with an account associated with the user and associated with a database (e.g., the user can access the associated data by logging into an account associated with the memory). In other embodiments, the system is configured to save the associated first purchasing data, first tracking information, and first shipping data; and the associated second purchasing data, second tracking information, and second shipping data to memory accessible to the user in any suitable way, including: 1) through a web browser; 2) through a social network associated with the user; and/or 3) through an electronic message, such as an email, SMS message, and/or social network message.

### The System Transmits Data to the User

At Step 320, the system receives the first tracking number from the user. The system may be configured receive the first tracking number from any suitable source, including, but not limited to: 1) a web form on a webpage accessed by the user; 2) a browser add-on installed on a client device associated with the user; 3) a mobile application installed on a client device by the user; and/or 4) a text message, email, and/or social network message sent by the user to an account accessible by the system.

The system may be configured to receive the first tracking number from the user in one or more forms. In a particular embodiment, the system is configured to receive the complete first tracking number as provided to the user (e.g., all of the alphanumeric characters provided as the first tracking number to the user). In other embodiments the system is configured to receive part of the first tracking number (e.g., the last four digits of the first tracking number). In still further embodiments, the system is configured to receive the first tracking number, or part of the first tracking number and a combination of other information provided to user including: 1) the first purchase order number included in the first purchasing data; 2) the first common carrier information associated with the first tracking information; and/or 3) the user data associated with the first purchase (e.g., user account information).

At Step 322, the system, at least partially in response to receiving the first tracking number, conveys the associated first purchasing data, first tracking information, and first shipping data to a client device associated with the user. In various embodiments, the system is configured to convey the first purchasing data, first tracking information, and first shipping data to the client device in any suitable way including, but not limited to: 1) through a web page accessed by the client device; 2) through an application associated with a social network associated with the user; 3) through an email, SMS, and/or social network message received by the client device; 4) through a mobile application associated with the client device; and/or 5) through a browser add-on associated with the client device.

Once received, in various embodiments, the client device may be configured to display the first purchasing data, the first tracking information, and the first shipping data to the user in any suitable way. In a particular embodiment, the client device is configured to display the first purchasing data, the first tracking information, and the first shipping data on a web page accessed by the user, on a social network associated with the user, in an email, SMS, social network and/or other suitable electronic message accessible by the user, in a mobile application associated with the client device, and/or in a browser add-on.

In various embodiments, the system is configured to enable the user to modify the first tracking information. The system may be configured to enable the user to modify the first tracking information in one or more suitable ways. In a particular embodiment, the system is configured to enable the user to modify the first tracking information by receiving a request from the user to modify the first tracking information, and then submitting the requested changes to the first tracking information through an API associated with the first common carrier. In other embodiments, the system is associated with the first common carrier and enables the user to modify the first tracking information by receiving the requested changes to the first tracking information from the user and making the requested changes to the first tracking information.

In particular embodiments, the system is configured to enable the user to modify the delivery date by selecting a user-selectable indicium and choosing a different delivery date (e.g., the user chooses the new delivery date on a different linked webpage). In other embodiments, the system is configured to enable the user to modify the delivery date by entering a new delivery date directly on the webpage or mobile application displaying the tracking information (e.g., by entering a date in a field on the webpage displaying the tracking information using a user input device such as a keyboard). In still other embodiments, the system is configured to enable the user to modify the delivery date in other ways such as by email, text message, social network message, or by phone.

The system may be configured to enable the user to modify the expected delivery date to any date. In a preferred embodiment, the system is configured to enable the user to only modify the expected delivery date to a future date. According to various embodiments, the system is configured to enable the user to modify the delivery date to a date that is within a few days of the original expected delivery date.

### Alternate Embodiments

Alternative embodiments of the system may comprise features that are, in some respects, similar to the various components described above. Selected distinguishing features of these alternative embodiments are discussed below.

Any of the Data Received by the System May be from a Social Network

In various embodiments, the system is configured to receive at least a portion of the purchasing data, the shipping data, and/or the tracking information discussed above from or through a social network (e.g., Facebook®). For example, the system may be configured to plug into the social network through an application (e.g., an API) to receive any or all of the above data. Additionally, the system may be configured to save and/or associate the received data with an account associated with the user on the social network.

### Any Messages to a User May be Via a Social Network

The system may be configured to, according to various embodiments, send any of the received data (e.g., the shipping data, purchasing data, and/or tracking information) to the user via a social network (e.g., Facebook®). For example, the user may input a tracking number, which is received by the system (e.g., at Step 320). The system may, in response to receiving the tracking number, return tracking information and/or at least a portion of the purchasing and shipping data associated with the tracking number via a mechanism associated with the social network, such as, by posting the tracking information (and/or other information) on a message board associated with the user, in a message on the social network associated with the user, via a picture, or video message, or by any other appropriate mechanism associated with the social network.

### Exemplary Purchase History Functionality

FIGS. 4A and 4B depict two exemplary embodiments of the Multi-Carrier Tracking Module 300. The following examples are provided to further enhance understanding of the present systems and methods. It should be understood that the present systems and methods may be embodied in many different forms and the following examples should not be construed as limited to the embodiments set forth herein. Rather, these embodiments are provided so that this disclosure will be thorough and complete, and will fully convey the scope of the present system and method to those skilled in the art.

FIG. 4A shows a screen shot of an exemplary Multi-Carrier Tracking webpage. Here, the system displays information regarding the parcel, including: the tracking number (“EA 042 619 590 US”), the delivery status (“In Transit”), the scheduled delivery date, the approximate delivery time, the last location, further delivery instructions (“Leave at: Front Door”), reference numbers, the date the parcel was shipped/billed, the type and weight of the parcel, the delivery address (“To:”), the common carrier (“USPS”) and shipping service (“Express Mail”). Additionally, FIG. 4A shows the shipping progress, including locations, and corresponding dates, times, and activity (e.g., Arrival Scan). FIG. 4A also depicts several user-selectable indicia, where the user can request to change various delivery details. In this example, the user can request to “Change Delivery,” “Request Status Updates,” and “Provide Delivery Instructions.”

FIG. 4B shows a screen shot of the exemplary webpage of FIG. 4A integrated as a “tab” in a social network. The embodiment shown in FIG. 4B shows substantially the same functionality as the example in FIG. 4A. In this example, the user accesses the system by logging in to their social network page and then using a social network application to view the features of the system.

### CONCLUSION

Many modifications and other embodiments of the present systems and methods will come to mind to one skilled in the art having the benefit of the teachings presented in the foregoing descriptions and associated drawings. Therefore, it is to be understood that the present systems and methods are not to be limited to the specific embodiments disclosed and that modifications and other embodiments are intended to be included within the scope of the appended claims. Although specific terms are employed herein, they are used in a generic and descriptive sense only and not for the purposes of limitation.

1. A computer system comprising:
at least one processor, wherein said computer system is configured for:
(A) receiving first purchasing data collected from a website associated with a first online retailer, the first purchasing data associated with a first purchase made by a user from the first online retailer;
(B) receiving first shipping data collected from an email account associated with the user, the first shipping data associated with the first purchase and wherein the first shipping data comprises a first tracking number associated with a first common carrier;
(C) receiving second purchasing data collected from a second retailer website and associated with a second purchase made by the user from the second online retailer;
(D) receiving second shipping data collected from the email account associated with the user, the second shipping data associated with the second purchase and wherein the second shipping data comprises a second tracking number associated with a second common carrier;
(E) receiving first tracking information associated with the first tracking number;
(F) receiving second tracking information associated with the second tracking number;
(G) associating the first tracking information and the first shipping data with the first purchasing data;
(H) associating the second tracking information and the second shipping data with the second purchasing data; and
(I) saving to memory:
the associated first purchasing data, first tracking information, and first shipping data; and
the associated second purchasing data, second tracking information, and second shipping data.

2. The computer system of claim 1, further configured for:
(A) receiving the first tracking number from the user;
(B) at least partially in response to receiving the first tracking number, conveying the associated first purchasing data, first tracking information, and first shipping data to a client device associated with the user;
wherein the client device is configured to display the first purchasing data, first tracking information, and the first shipping data to the user.

3. The computer system of claim 2, wherein:
(A) the first purchasing data comprises a purchase order number associated with the first purchase;
(B) the first shipping data comprises the purchase order number associated with the first purchase; and
(C) associating the first tracking information and the first shipping data with the first purchasing data comprises associating the first shipping data with the first purchasing data via the purchase order number.

4. The computer system of claim 3, wherein associating the first shipping data with the first purchasing data via the purchase order number comprises:
(A) detecting that the first purchasing data and the first shipping data are associated with the purchase order number associated with the first purchase; and
(B) associating the first purchasing data, the first shipping data, and the first tracking information with a common identifier.

5. The computer system of claim 3, wherein the first tracking information comprises information selected from a group consisting of:
(A) an expected delivery date of one or more parcels containing one or more items of the first purchase; and
(B) a delivery status for the one or more parcels.

6. The computer system of claim 5, wherein:
(A) the first tracking information comprises an expected delivery date of the one or more parcels containing one or more items of the first purchase; and
(B) the computer system is further configured for enabling the user to modify the expected delivery date of the one or more parcels.

7. The computer system of claim 6, wherein the client device is configured to display a user-selectable indicium that enables the user to modify the expected delivery date of the one or more parcels.

8. The computer system of claim 1, wherein the first online retailer and the second online retailer are the same online retailer.

9. The computer system of claim 1, wherein the first shipping data is collected from the email account associated with the user by scraping the email account.

10. The computer system of claim 1, wherein the first shipping data is collected from the email account associated with the user via a plug-in associated with the email account.

11. The computer system of claim 10, wherein the plug-in is further associated with a logistics company.

12. A computer system comprising:
at least one processor, wherein said computer system is configured for:
(A) receiving purchasing data collected from a plurality of websites, the purchasing data associated with a plurality of purchases made by a user;
(B) receiving shipping data associated with the user, the shipping data associated with the plurality of purchases, wherein the shipping data comprises one or more tracking numbers associated with one or more common carriers;
(C) receiving tracking information associated with each of the one or more tracking numbers;
(D) receiving a particular tracking number from the user;
(E) determining if the one or more tracking numbers comprise the particular tracking number; and
(F) if the one or more tracking numbers comprise the particular tracking number;
i. identifying one or more particular purchases of the plurality of purchases the particular tracking number is associated with; and
ii. sending, to a client device associated with the user, at least a portion of the purchasing data associated with the one or more particular purchases.

13. The computer system of claim 12, wherein the computer system is further configured for saving the received shipping and purchasing data to an account associated with the user.

14. The computer system of claim 13, wherein the computer system is further configured for enabling the user to access the account associated with the user.

15. The computer system of claim 14, wherein the computer system is further configured for, if the one or more tracking numbers comprise the particular tracking number, sending to the client device associated with the user:
(A) at least a portion of the shipping data associated with the one or more particular purchases; and
(B) at least a portion of the tracking information associated with the particular tracking number.

16. The computer system of claim 15, wherein:
(A) the particular tracking number is associated with one or more parcels used to ship one or more items associated with the one or more particular purchases; and
(B) at least the portion of the tracking information associated with the particular tracking number comprises an expected delivery date for the one or more parcels.

17. The computer system of claim 16, wherein the computer system is further configured for, at least partially in response to enabling the user to access the account associated with the user, enabling the user to modify the expected delivery date for the one or more parcels.

18. The computer system of claim 12, wherein the particular tracking number is associated with a first common carrier.

19. The computer system of claim 18, wherein the computer system is further configured for:
(A) receiving a second particular tracking number from the user;
(B) determining if the one or more tracking numbers comprise the second particular tracking number; and
(C) if the one or more tracking numbers comprise the second particular tracking number:
i. identifying one or more particular purchases of the plurality of purchases the second particular tracking number is associated with; and
ii. sending, to a client device associated with the user, at least a portion of
the second purchasing data associated with the one or more particular purchases, wherein the second particular tracking number is associated with a second common carrier.

20. The computer system of claim 19, wherein the first tracking information is received from one or more servers associated with the first common carrier.

21. A non-transitory computer-readable medium storing computer executable instructions for:
(A) detecting a first purchase from a first online retailer by a first user;
(B) collecting, from a website of the first online retailer, first purchasing data associated with the first purchase;
(C) collecting, from an email account associated with the first user, first shipping data associated with the first purchase, wherein the first shipping data comprises a first tracking number associated with one or more parcels associated with a first common carrier;
(D) detecting a second purchase from a second online retailer by the first user;
(E) collecting, from a website of the second online retailer, second purchasing data associated with the second purchase;
(F) collecting, from the email account associated with the first user, second shipping data associated with the second purchase, wherein the second shipping data comprises a second tracking number associated with one or more parcels associated with a second common carrier; and
(G) sending, to a computer system:
1. the first purchasing data;
2. the first shipping data;
3. the second purchasing data; and
4. the second shipping data;
wherein the computer system is configured to receive the first tracking number and, at least partially based on receiving the first tracking number, request, from the first common carrier, tracking information associated with the first tracking number.

22. The non-transitory computer-readable medium of claim 21, further storing computer executable instructions for receiving, from the computer system:
(A) the first purchasing data;
(B) the first shipping data; and
(C) the first tracking information.

23. The non-transitory computer-readable medium of claim 22, further storing computer executable instructions for displaying the first purchasing data, the first shipping data, and the first tracking information.

24. The non-transitory computer-readable medium of claim 22, wherein the first tracking information comprises:
(A) an expected delivery date for the one or more parcels associated with the first common carrier; and
(B) a delivery status for the one or more parcels associated with the first common carrier.

25. The non-transitory computer-readable medium of claim 24, further storing computer executable instructions for enabling the user to modify the expected delivery date for the one or more parcels associated with the first common carrier.
